(19) United States
(12) Patent Application Publication
(10) Pub. No.: US 2013/0170548 A1
(43) Pub. Date: Jul. 4, 2013

(54) VIDEO ENCODING DEVICE, VIDEO DECODING DEVICE, VIDEO ENCODING METHOD, VIDEO DECODING METHOD AND PROGRAM

(71) Applicants: Hirofumi Aoki, Tokyo (JP); Keiichi Chono, Tokyo (JP); Kenta Senzaki, Tokyo (JP); Junji Tajime, Tokyo (JP)

(72) Inventors: Hirofumi Aoki, Tokyo (JP); Keiichi Chono, Tokyo (JP); Kenta Senzaki, Tokyo (JP); Junji Tajime, Tokyo (JP)

(73) Assignee: NEC CORPORATION, Tokyo (JP)

(21) Appl. No.: 13/813,612

(22) PCT Filed: Jul. 29, 2011
(86) PCT No.: PCT/JP2011/067454

§ 371 Date: Mar. 7, 2013

(30) Foreign Application Priority Data
Aug. 3, 2010 (JP) 2010-174156

(51) Int. Cl. H04N 7/26

(52) U.S. Cl. CPC H04N 19/00569
USPC 375/240.12

(57) ABSTRACT

The present invention is a video encoding device having: video encoder for encoding an inputted video on the basis of a prediction; reference picture compressor for compressing a reference picture used for the prediction; storage for storing the compressed reference picture; reference picture decompressor for decompressing the compressed reference picture stored in the storage; compression and decompression controller for controlling the reference picture compressor and the reference picture decompressor on the basis of predetermined control information; quantized information encoder for encoding a portion of the control information of the compression and decompression control means by means of a predetermined method and for generating a quantized information bitstream; and multiplexer for multiplexing the video bitstream from the video encoder, at least a portion of the control information excluding the portion that was encoded by means of the quantized information encoder, and the quantized information bitstream.

### TECHNICAL FIELD

The present invention relates to a video encoding device, a video decoding device, a video encoding method, a video decoding method and a program therefor.

### BACKGROUND ART

The video encoding device performs an encoding process in accordance with a predetermined video encoding technique for each frame of an input video, thereby to generate encoded data, namely, a bitstream. ISO/IEC 14496-10 Advanced Video Coding (AVC) of Non-Patent Literature 1, being a typified example of the predetermined video encoding technique, divides each frame into blocks each having a 16×16 pixel size that is called MB (Macro Block), furthermore divides the aforementioned MB into blocks each having a 4×4 pixel size (hereinafter, referred to as a 4×4 block), and assumes the aforementioned 4×4 block to be a unit of a minimum configuration for the encoding. In FIG. 1, an example of the block division is shown in a case in which a color format of the frame is an YCbCr 4:2:0 format and a space resolution is a QCIF (Quarter Common Intermediate Format).

The divided block is encoded based on an intra-frame prediction or an inter-frame prediction. The intra-frame prediction is a method of predicting an image by employing a reconstructed image of the current encoding-target frame. The inter-frame prediction is a method of predicting an image by employing a reconstructed image of the frame encoded in the past rather than the current encoding-target frame. The video encoding device that predicts and encodes the image from the reconstructed image of the already-encoded image in such a manner includes a video encoder 101 that encodes the input images, and a reference picture memory 102 that stores the frames (hereinafter, referred to as a reference picture) including the reconstructed images to be referenced in the prediction, as shown in FIG. 2.

Additionally, the image frame encoded by applying the intra-frame prediction for all MBs within the frame is called I picture. The image frame encoded by applying the inter-frame prediction employing at most one sheet of the reference picture per each MB for each MB besides the intra-frame prediction is called P picture. In addition, the image frame encoded by applying the inter-frame prediction simultaneously employing a plurality of the reference pictures for each MB is called B picture. As a rule, the I picture is set at a constant interval, and a section comprised of a plurality of the frames to be partitioned with this I picture is called GOP (Group of Pictures).

By the way, it is described in Patent-Literature 1 that the video decoding device for decoding the output bitstream of the above-described video encoding device and obtaining the decoded video, which includes a memory compressor 203 and a memory decompressor 204 for performing lossy compression and decompression for the reference pictures based on Differential Pulse Code Modulation (DPCM), respectively, stores the reference pictures into the reference picture memory by applying lossy compression therefor, as shown in FIG. 3.

### CITATION LIST

### Patent Literature

PTL 1: International Publication: WO2007091588

### Non-Patent Literature

NON-PTL 1: ISO/IEC 14496-10 Advanced Video Coding
NON-PTL 2: Reiko Noda, Takashi Chujou, Improving Video Coding Efficiency by pixel Bit-depth Increase, Forum on Information technology 2006, J-009, 2006

### SUMMARY OF INVENTION

### Technical Problem

However, when the lossy compression processing is applied for the reference picture only in the video decoding device, it is not guaranteed that the pixel value of the reference picture completely coincides between the video encoding device and the video decoding device. Therefore, in the above-described video encoding technology and video decoding technology, a problem surfaces of degradation in an image quality of the decoded video caused by an inconsistency between the above-mentioned reference picture pixel values. In other words, so as to maintain the image quality of the decoded video, a larger data amount is required in the video encoding, which causes a problem that a transmission path between the video encoding device and the video decoding device is oppressed.

Thereupon, the present invention has been accomplished in consideration of the above-mentioned problems, and an object of the present invention is to provide a video encoding device, a video decoding device, a video encoding method, a video decoding method and a program that reduces a memory capacity and a memory domain while suppressing a data transfer amount necessary for obtaining a predetermined decoded video image quality between the video encoding device and the video decoding device without causing an inconsistency between the reference picture pixel values to occur between the video encoding device and the video decoding device.

### Solution to Problem

The present invention is a video encoding device, comprising: a video encoding means that encodes an input video based on a prediction; a reference picture compressing means that compresses a reference picture to be employed for said prediction; a reference picture storing means that stores said compressed reference picture; a reference picture decompressing means that decompresses the compressed reference picture stored into said reference picture storing means; a compression and decompression controlling means that controls said reference picture compressing means and said reference picture decompressing means based on predetermined control information; a quantized information encoding means that encodes one part of the control information of said compression and decompression controlling means with a predetermined method and generates a quantized information bitstream; and a multiplexing means that multiplexes the video bitstream of said video encoding means, at least the control information other than the information encoded by said quantized information encoding means, out of said control information, and said quantized information bitstream.

The present invention is a video decoding device, comprising: a demultiplexing means that demultiplexes a bitstream in which a quantized information bitstream having one part of control information of a compression and decompression control encoded therein, the control information other than said one part of the information, and a video bitstream have been multiplexed; a quantized information decoding means that decodes the demultiplexed quantized information bitstream with a predetermined method, and extracts said control information of the compression and decompression control; a video decoding means that decodes the demultiplexed video bitstream based on a prediction; a reference picture compression means that compresses a reference picture to be employed for said prediction; a reference picture storing means that stores said compressed reference picture; a reference picture decompressing means that decompresses the compressed reference picture stored into said reference picture storing means; and a compression and decompression controlling means that controls said reference picture compressing means and said reference picture decompressing means based on said demultiplexed control information and said extracted control information.

The present invention is a video encoding method, comprising: encoding an input video based on a prediction; compressing a reference picture to be employed for said prediction based on a predetermined control information; storing said compressed reference picture; decompressing said stored compressed reference picture based on said predetermined control information; encoding one part of said control information with a predetermined method and generating a quantized information bitstream; and multiplexing said encoded video bitstream, said quantized information bitstream, at least the control information other than said encoded information.

The present invention is a video decoding methods, comprising: demultiplexing a bitstream in which a quantized information bitstream having one part of control information of a compression and decompression control encoded therein, at least the control information of the compression and decompression control other than said one part of the information, and a video bitstream have been multiplexed; decoding the demultiplexed quantized information bitstream with a predetermined method, and extracting said control information of the compression and decompression control; decoding the demultiplexed video bitstream based on a prediction; compressing a reference picture to be employed for said prediction based on said demultiplexed control information and said extracted control information; storing said compressed reference picture; and decompressing said stored compressed reference picture based on said demultiplexed control information and said extracted control information.

The present invention is a program for causing an information processing device to execute the processes of: encoding an input video based on a prediction; compressing a reference picture to be employed for said prediction based on a predetermined control information; storing said compressed reference picture; decompressing said stored compressed reference picture based on said control information; encoding one part of said control information with a predetermined method and generating a quantized information bitstream; and multiplexing said encoded video bitstream, said quantized information bitstream, and the control information other than said encoded information.

The present invention is a program for causing an information processing device to execute the processes of: demultiplexing a bitstream in which a quantized information bitstream having one part of control information of a compression and decompression control encoded therein, the control information other than said one part of the information, and a video bitstream have been multiplexed; decoding the demultiplexed quantized information bitstream with a predetermined method, and extracting said control information; decoding the demultiplexed video bitstream based on a prediction; compressing a reference picture to be employed for said prediction based on said demultiplexed control information and said extracted control information; storing said compressed reference picture; and decompressing said stored compressed reference picture based on said demultiplexed control information and said extracted control information.

### Advantageous Effect of Invention

The present invention makes it possible to allow the pixel value of the reference picture to completely coincide between the video encoding device and the video decoding device, whereby degradation in the image quality of the decoded video caused by an inconsistency between the reference picture pixel values is cancelled. In other words, a data transfer amount that is required in order to maintain the image quality of the decoded image between the video encoding device and the video decoding device can be suppressed. In addition, in accordance with the present invention, the memory capacity and the memory domain are reduced not only in the video decoding device and but also in the video encoding device.

### BRIEF DESCRIPTION OF DRAWINGS

FIG. 1 is a view illustrating an example of dividing the block of the frame.

FIG. 2 is a view illustrating the related video encoding device.

FIG. 3 is a view illustrating the related video decoding device.

FIG. 4 is a view illustrating the video encoding device of a first exemplary embodiment.

FIG. 5 is a flowchart of a video encoding process by the video encoding device relating to the first exemplary embodiment.

FIG. 6 is a view illustrating a situation in which one certain line in a horizontal direction is subjected to the DPCM compression at a processing interval of eight pixels and at a predicted error precision of five bits in the reconstructed image having a pixel bit precision of eight bits, and is stored into the reference picture memory 102.

FIG. 7 is a view illustrating a situation in which one certain line in a horizontal direction of the reference picture having a pixel bit precision of eight bits is decompressed from data subjected to the DPCM compression at a processing interval of eight pixels and at a predicted error precision of five bits, and is supplied to the video encoder 101.

FIG. 8 is a view illustrating an example of multiplexing DPCM auxiliary information to a sequence parameter.

FIG. 9 is a view illustrating an example of multiplexing a quantized representative value array to be contained in the DPCM auxiliary information.

FIG. 10 is a view illustrating an example of multiplexing the DPCM auxiliary information to a picture parameter.

FIG. 11 is a block diagram of the video decoding device relating to a second exemplary embodiment of the present invention.

FIG. 12 is a flowchart of a video decoding process by the video decoding device relating to the second exemplary embodiment.

FIG. 13 is a block diagram of the video encoding device relating to a third exemplary embodiment of the present invention.

FIG. 14 is a view illustrating an example of multiplexing the DPCM auxiliary information to the sequence parameter.

FIG. 15 is a view illustrating an example of multiplexing quantized representative value array transform data.

FIG. 16 is a view illustrating an example of multiplexing the quantized representative value array transform data.

FIG. 17 is a view illustrating an example of multiplexing the quantized representative value array transform data.

FIG. 18 is a view illustrating an example of multiplexing the DPCM auxiliary information to the picture parameter.

FIG. 19 is a block diagram of the video decoding device relating to a fourth exemplary embodiment of the present invention.

FIG. 20 is a view illustrating a configuration of an information processing device of the present invention.

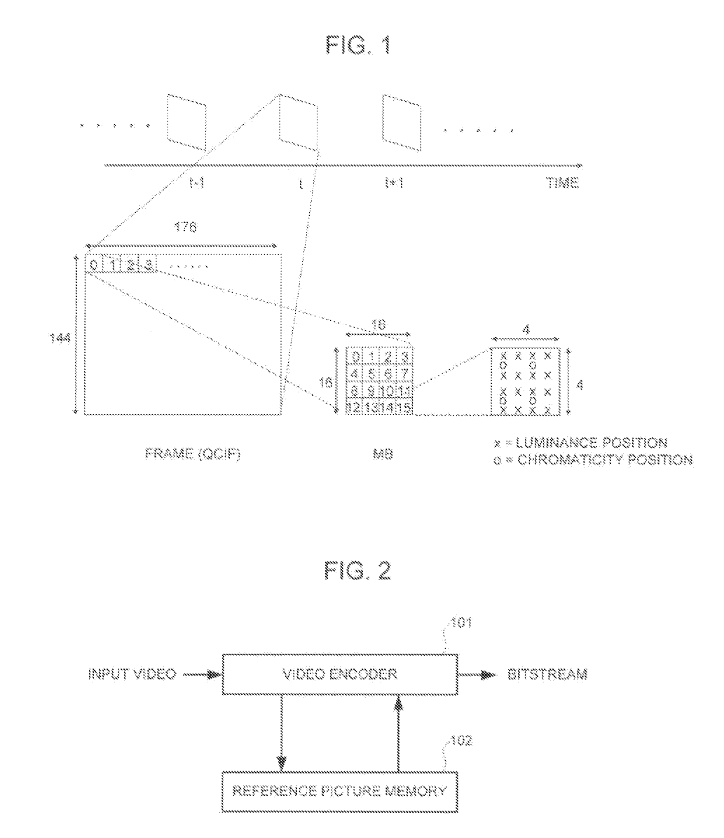

### DESCRIPTION OF EMBODIMENTS

Hereinafter, the exemplary embodiments of the present invention will be explained by referencing the accompanied drawings.

### First Exemplary Embodiment

FIG. 4 is a block diagram of the video encoding device relating to the first exemplary embodiment of the present invention. As shown in the figure, the video encoding device relating to the first exemplary embodiment differs in a point of newly including a memory compressor 103, a memory decompressor 104, a multiplexer 105, and a memory compression and decompression controller 106 as compared with the video encoding device shown in FIG. 2.

The video encoder 101 encodes each frame of the input video, and supplies a video bitstream thereof to the multiplexer 105. Further, when the video encoder 101 encodes encoding-target frames by employing the intra-frame prediction or the inter-frame prediction for them, it loads the reference picture to be employed for the prediction via the memory decompressor 104 from the reference picture memory 102. Besides, the video encoder 101 stores the reconstructed image of the image for which the encoding has been completed into the reference picture memory 102 as the reference picture via the memory compressor 103.

The memory compressor 103 performs a predetermined compressing process specified by control information to be supplied from the memory compression and decompression controller 106 for the reconstructed image that is supplied from the video encoder 101, and stores the obtained compressed data into the reference picture memory 102.

The memory decompressor 104 reads out the compressed data including a requested image region from the reference picture memory 102 responding to a request by the video encoder 101, performs a predetermined decompressing process specified by the control information to be supplied from the memory compression and decompression controller 106 for the above compressed data, and transmits it to the video encoder 101 as the reference picture.

The memory compression and decompression controller 106 supplies the control information specifying an operation of the memory compression and the memory decompression to the memory compressor 103, the memory decompressor 104, and the multiplexer 105, respectively.

The multiplexer 105 multiplexes the video bitstream and the above-mentioned control information, and output them as a bitstream.

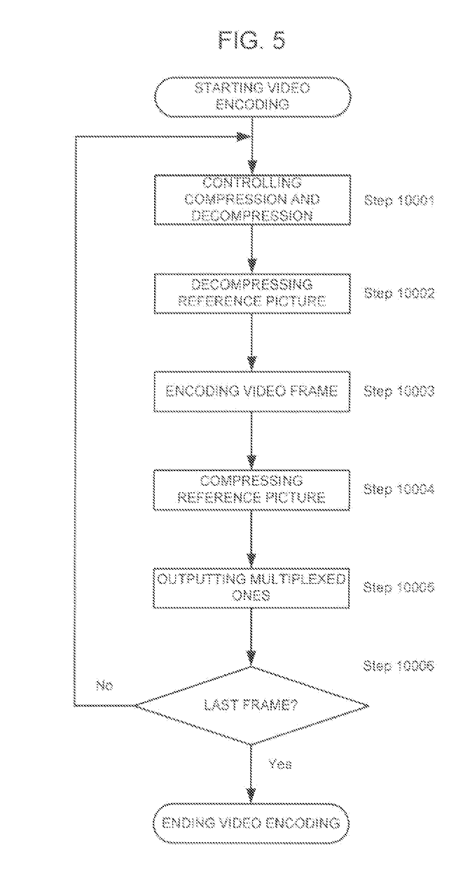

Next, the video encoding process by the video encoding device relating to the first exemplary embodiment will be explained by referencing a flowchart of FIG. 5.

In a step S10001, the memory compression and decompression controller 106 supplies the control information specifying an operation of the memory compression and the memory decompression to the memory compressor 103, the memory decompressor 104, and the multiplexer 105, respectively.

In a step S10002, the memory decompressor 104 reads out, from the reference picture memory 102, the compressed data including a requested image region that is requested as the reference picture from the video encoder 101, based on the supplied control information, performs a predetermined decompressing process therefor, and supplies it to the video encoder 101.

In a step S10003, the video encoder 101 encodes each frame of the input video, and supplies a video bitstream thereof to the multiplexer 105.

In a step S10004, the memory compressor 103 performs a predetermined compressing process for the reconstructed image that is supplied from the video encoder 101, based on the supplied control information, and stores it as compressed data into the reference picture memory 102.

In a step S10005, the multiplexer 105 multiplexes the video bitstream and the above-mentioned control information, and output them as the bitstream.

In a step S10006, when the bitstream outputted in the step S10005 corresponds to the last frame that should be encoded, the video encoding is finished. When it is not the last frame, the operation returns to S10001.

Making a configuration in such a manner enables the memory capacity and the memory domain to be reduced in the video encoding device without causing an inconsistency of the reference picture pixel value to occur between the video encoding device and the video decoding device. In other words, the memory capacity and the memory domain can be reduced in the video encoding device while the data transfer amount necessary for maintaining the image quality of the decoded video between the video encoding device and the video decoding device is suppressed. The reason is that the multiplexer 105 receives the control information specifying an operation of the memory compression and the memory decompression in the video encoding device from the memory compression and decompression controller 106, multiplexes it to the bitsream, and transmits the above-mentioned control information to the video decoding device, thereby enabling the video decoding device to perform a memory compressing and decompressing process identical to the memory compressing and decompressing process that the video encoding device performs.

### Example 1

A specific example 1 of the above-mentioned video encoding device relating to the first exemplary embodiment will be explained below.

In this example, it is assumed that the memory compressor 103 and the memory decompressor 104 performs the compression and decompression based on the DPCM for encoding the predicted error at M bits with the processing interval assumed to be N pixels, respectively.

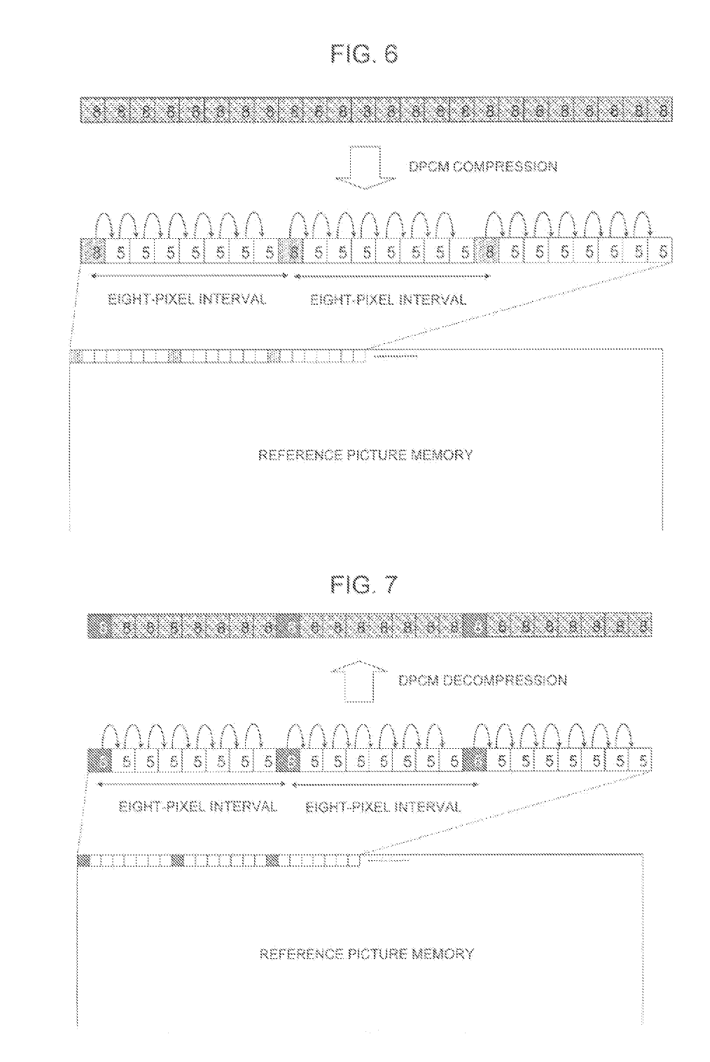

The memory compressor 103 performs a compressing process for the reconstructed image to be supplied from the video encoder 101 by applying the DPCM of M bits for every horizontal-direction N pixels, and stores the obtained compressed data into the reference picture memory 102 as DPCM compressed data. In FIG. 6, as an example, a situation is shown in which one certain horizontal-direction line is subjected to the DPCM compression at a processing interval of eight pixels and at a predicated error precision of five bits in the reconstructed image having a pixel bit precision of eight bits, and is stored into the reference picture memory 102.

The memory decompressor 104 reads out the DPCM compressed data including a requested image region from the reference picture memory 102 responding to a request by the video encoder 101, decompresses it, and transmits it to the video encoder 101. In FIG. 7, as an example, a situation is shown in which one certain horizontal-direction line of the reference picture having a pixel bit precision of eight bits is decompressed from data subjected to the DPCM compression at a processing interval of eight pixels and at a predicated error precision of five bits and is supplied to the video encoder 101.

Herein, an operation of the compression and the decompression by the DPCM will be specifically explained.

When a pixel value of the input images by a portion of the processing interval is x(n) (n=0, 1, . . . , N−1), a compressed output signal y(n) (n=0, 1, . . . , N−1) can be obtained from Equation (1).

$$\begin{matrix}[ Numerical equation 1 ] & \\ y ( x ) = \{ \begin{matrix}x ( n ) ; & n = 0 \\ epqridx ( n ) ; & n \neq 0\end{matrix} & Equation ( 1 )\end{matrix}$$

A leading pixel value x(0) of a pixel value sequence is losslessly encoded with the PCM as a reference pixel of the prediction, and the inputted pixel value is preserved as y(0) as it stands. Each of pixel values other than this become an index value epqridx(n) for a quantized representative value of x(n) selected from a predetermined quantized representative value array epqr(i) (i=0, 1, . . . , 2^{M}−1). epqridx(n) is obtained by employing Equation (2), Equation (3), Equation (4), and Equation (5).

[Numerical equation 2]

epqridx(n)=arg min_{i=0, . . . , 2}_{^{M}}₋₁[|epqr(i)−ep(n)|] Equation (2)

[Numerical equation 3]

ep(n)=x(n)−xp(n) Equation (3)

[Numerical equation 4]

xp(n)=xr(n−1) Equation (4)

[Numerical equation 5]

xr(n)=xp(n)+epqr(epqridx(n)) Equation (5)

Where, ep(n) denotes a predicted error, xp(n) denotes a predicted pixel value, and xr(n) denotes a decoded pixel value.

The decompression of an output signal x(n)′ is obtained by Equation (6).

$$\begin{matrix}[ Numerical equation 6 ] & \\ {x ( n )}^{′} = \{ \begin{matrix}y ( n ) ; & n = 0 \\ {x ( n - 1 )}^{′} + epqr ( epqridx ( n ) ) ; & n \neq 0\end{matrix} & Equation ( 6 )\end{matrix}$$

Further, the DPCM compression employing Equation (7) and Equation (8) instead of Equation (3) and Equation (5) is enabled by utilizing a complement notation.

[Numerical equation 7]

ep(n)=(x(n)−xp(n)+L)%L Equation (7)

[Numerical equation 8]

xr(n)=(xp(n)−epqr(epqridx(n)+L)%L Equation (8)

Where, L is a value (L=2̂B) that is uniquely decided from a pixel bit precision B of the reference picture.

As apparent from the above-mentioned explanation, the information associated with the processing interval N of the DPCM and the bit number M enables an operation of the compression and decompression based on the DPCM to be specified under a condition that an element value of the quantized representative value array is a fixed value. Furthermore adding the information associated with the element values of 2̂M quantized representative value arrays enables an operation of the compression and decompression based on the DPCM to be specified under a condition that an element value of the quantized representative value array is a variable value. In a case of utilizing the quantized representative value arrays in a plural number, it is enough to furthermore add the information associated with the element values of 2̂M quantized representative value arrays of which the number is equivalent to its number. In examples mentioned above, an operation of the memory compression and memory decompression are specified with the control information including the processing interval N of the DPCM, the bit number M, and the element value of the quantized representative value array. Hereinafter, the control information including the processing interval N of the DPCM, the bit number M, and the element value of the quantized representative value array is called DPCM auxiliary information.

Above, an explanation relating to an operation of the compression and the decompression by the DPCM is finished.

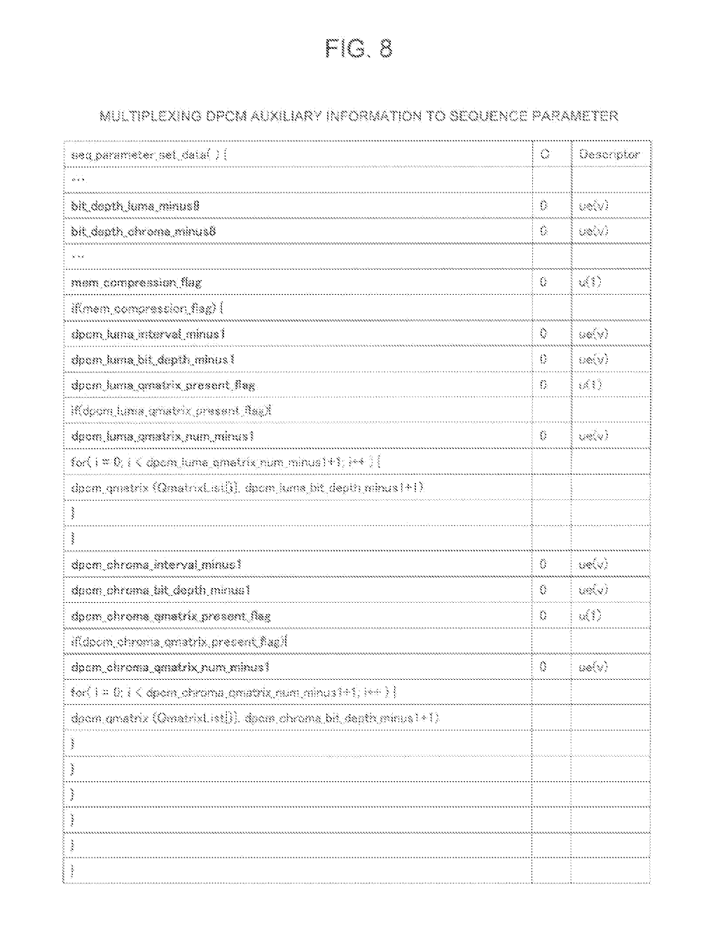

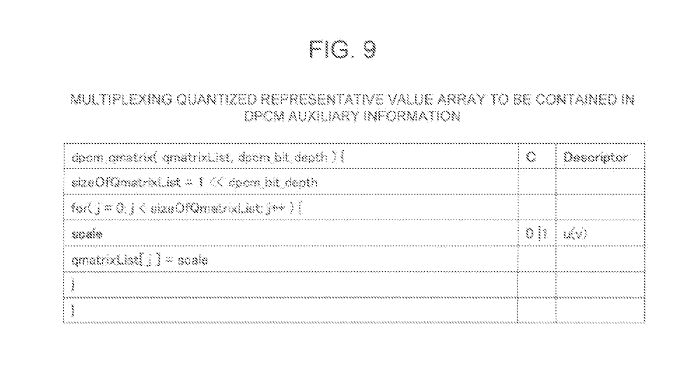

The DPCM auxiliary information may be multiplexed to the sequence parameter, for example, in accordance with the description of “Specification of syntax functions, categories, and descriptors” of the Non-Patent literature 1, as exemplified in lists of FIG. 8 and FIG. 9. The multiplexing may be performed for each GOP, being a random access interval.

Additionally, mem_compression_flag signifies whether or not to apply the DPCM compression for the reference picture. 1 signifies that the DPCM compression is applied, and 0 signifies that the DPCM compression is not applied

Further, dpcm_luma_interval_minus1 denotes a value obtained by subtracting 1 from the processing interval N of the DPCM compression for a luminance signal. When a decoded value of dpcm_luma_interval_minus1 is 0, the DPCM compression must not applied for the reference picture of the luminance signal.

Further, dpcm_luma_bit_depth_minus1 denotes a value obtained by subtracting 1 from the bit number M of the DPCM compression for the luminance signal. When a decoded value of dpcm_luma_interval_minus1 is 0, dpcm_luma_bit_depth_minus1 must be a value obtained by adding 7 to bit_depth_luma_minus8.

Further, dpcm_luma_qmatrix_present_flag signifies whether or not a quantized representative value array having an element different from that of the quantized representative value array of the specified value exists in the DPCM compression to be employed for the luminance signal. 1 signifies that it exists, and 0 signifies that it does not exist. When a decoded value of dpcm_luma_interval_minus1 is 0, dpcm_luma_qmatrix_present_flag must be 0.

Further, dpcm_luma_qmatrix_num_minus1 denotes a value obtained by subtracting 1 from the number of the quantized representative value arrays of the DPCM compression to be employed for the luminance signal.

Further, dpcm_chroma_interval_minus1 denotes a value obtained by subtracting 1 from the processing interval N of the DPCM compression for a chromaticity signal. When a decoded value of dpcm_chroma_interval_minus1 is 0, the DPCM compression must not applied for the reference picture of the chromaticity signal.

Further, dpcm_chroma_bit_depth_minus1 denotes a value obtained by subtracting 1 from the bit number M of the DPCM compression for the chromaticity signal. When a decoded value of dpcm_chroma_interval_minus1 is 0, dpcm_chroma_bit_depth_minus1 must be a value obtained by adding 7 to bit_depth_chroma_minus8.

Further, dpcm_chroma_qmatrix_present_flag signifies whether or not a quantized representative value array having an element different from that of the quantized representative value array of the specified value exists in the DPCM compression to be employed for the chromaticity signal. 1 signifies that it exists, and 0 signifies that it does not exist. When a decoded value of dpcm_chroma_interval_minus1 is 1, dpcm_chroma_qmatrix_present_flag must be 0.

Further, dpcm_chroma_qmatrix_num_minus1 denotes a value obtained by subtracting 1 from the number of the quantized representative value arrays of the DPCM compression to be employed for the chromaticity signal.

Further, scale denotes each element of the quantized representative value array. The bit number is a sample bit number of the corresponding component (luminance or chromaticity).

Above, an explanation of an example of multiplexing the DPCM auxiliary information in FIG. 8 and FIG. 9 is finished.

In this example, with regard to the DPCM auxiliary information, an example of multiplexing the DPCM auxiliary information to the bitstream for the luminance signal and the chromaticity signal was shown in FIG. 8 and FIG. 9, respectively. However, in accordance with the present invention, it may be acceptable to have, for example, only one common set of the DPCM auxiliary information. Further, it may be acceptable to have, for example, different DPCM auxiliary information for all color planes. In addition, with regard to an entirety or one part of the auxiliary information, a fixed value common to the video encoding device and the video decoding device may be set.

Further, in this example, with regard to the DPCM auxiliary information, an example of multiplexing the information of a plurality of the quantized representative value arrays to the bitstream was shown in FIG. 8 and FIG. 9. In such examples, in the present invention, it is also possible to switch the quantized representative value array for each processing interval of the DPCM by multiplexing index information of the quantized representative value array selected by the memory compressor of the video encoding device to the DPCM compressed data.

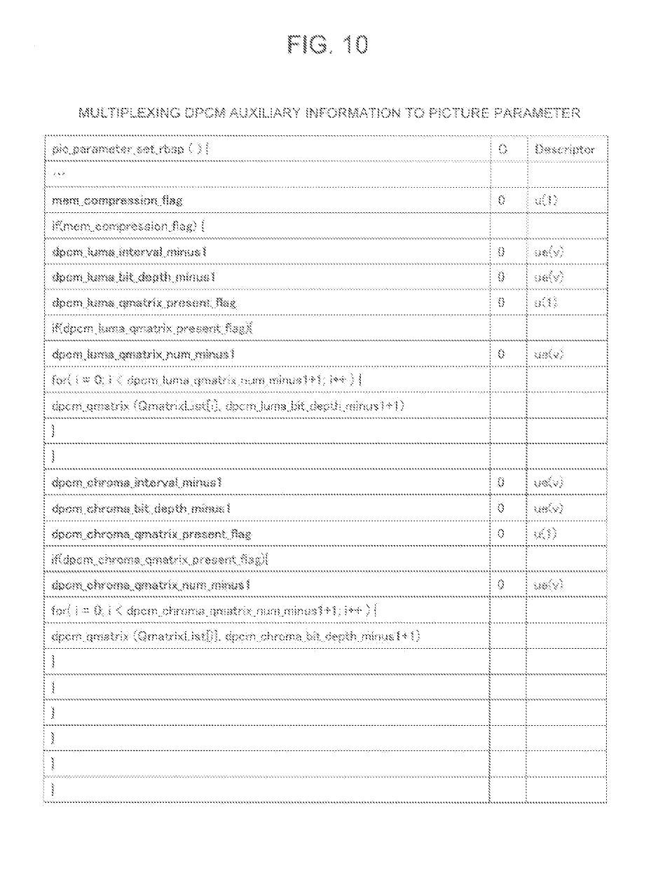

Further, an example of multiplexing the DPCM auxiliary information to the sequence parameter was shown. However, in accordance with the present invention, for example, the DPCM auxiliary information may be multiplexed in the picture parameter to be employed for by-frame encoding and decoding as exemplified in lists of FIG. 10 and FIG. 9. Multiplexing the DPCM auxiliary information to the picture parameter in such a manner makes it possible switch the special feature of the DPCM compression in a unit of the frame.

Above, an explanation of the video encoding device relating to the first exemplary embodiment of the present invention is finished.

### Second Exemplary Embodiment

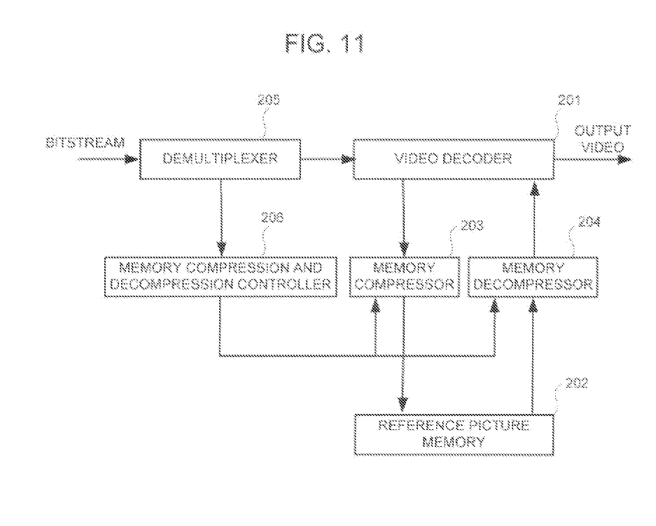

FIG. 11 is a block diagram of the video decoding device relating to the second exemplary embodiment of the present invention.

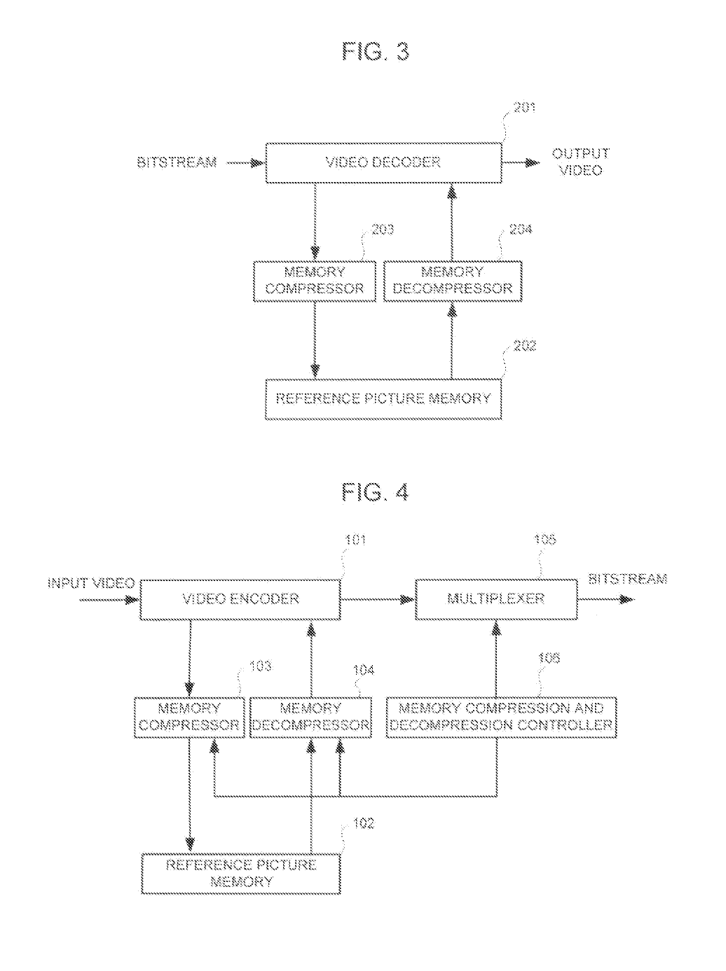

As shown in the figure, the video decoding device relating to the second exemplary embodiment differs in a point of newly including a demultiplexer 205 and a memory compression and decompression controller 206 as its constituent element, as compared with the video decoding device shown in FIG. 3. Operations of a memory compressor 203 and a memory decompressor 204 are identical to the operations of the memory compressor 103 and the memory decompressor 104 in the video encoding device relating to the first exemplary embodiment, respectively, so each block of a video decoder 201, the demultiplexer 205, and the memory compression and decompression controller 206 will be explained hereinafter.

The demultiplexer 205 demultiplexes the bitstream, and extracts the video bitstream and the control information specifying an operation of the memory compression and the memory decompression. Further, the demultiplexer 205 supplies the extracted control information and the extracted video bitstream to the memory compression and decompression controller 206 and the video decoder 201, respectively.

The memory compression and decompression controller 206 sets operations of the memory compressor 203 and the memory decompressor 204 based on the supplied control information so that they executes the reference picture compression and the reference picture decompression identical to those of the video encoding device, respectively.

The video decoder 201 decodes the video bitstream, and outputs the obtained reconstructed image as the decoded image. When the video decoder 201 applies the intra-frame prediction or the inter-frame prediction in the decoding process at the moment of decoding the video bitstream, it loads the reference picture to be employed for the prediction via the memory decompressor 204 from a reference picture memory 202. Besides, the video decoder 201 stores the reconstructed image for which the decoding has been completed as the reference picture into the reference picture memory 202 via the memory compressor 203.

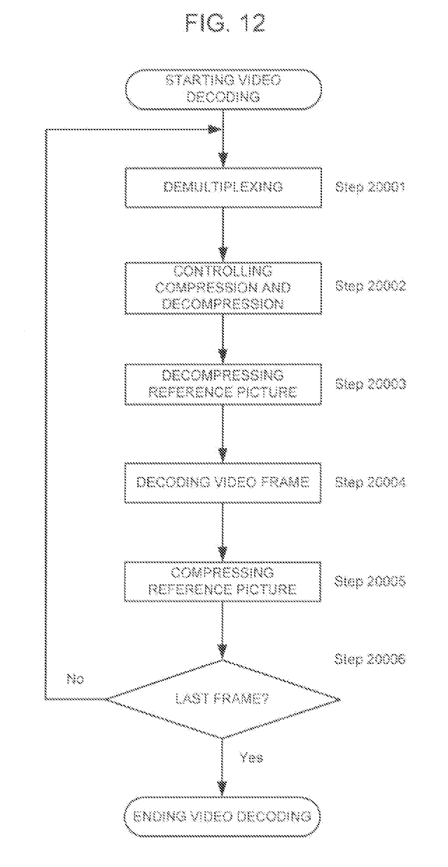

Next, the video decoding process by the video decoding device relating to the second exemplary embodiment will be explained by referencing a flowchart of FIG. 12.

In a step S20001, the demultiplexer 205 demultiplexes the bitstream, and extracts the video bitstream and the control information specifying an operation of the memory compression and the memory decompression.

In a step S20002, the memory compression and decompression controller 206 sets operations of the memory compressor 203 and the memory decompressor 204 based on the control information to be supplied.

In a step S20003, the memory decompressor 204 reads out, from the reference picture memory 202, the compressed data including a requested image region that is requested as the reference picture from the video decoder 201, performs a predetermined decompressing process based on the supplied control information mentioned above, and supplies it to the video decoder 201 as the reference picture.

In a step S20004, the video decoder 201 decodes the video bitstream, and outputs the obtained reconstructed image as the decoded video. Further, the video decoder 201 stores the reconstructed image for which the decoding has been completed into the reference picture memory 202 via the memory compressor 203 as the reference picture.

In a step S20005, the memory compressor 203 performs a predetermined compressing process for the decoded image that is supplied from the video encoder 201, based on the supplied control information mentioned above, and stores it as compressed data into the reference picture memory 202.

In a step S20006, when the bitstream decoded in the step S20004 corresponds to the last frame that should be decoded, the video decoding is finished. When it is not the last frame, the operation returns to S20001.

Making a configuration in such a manner enables the memory capacity and the memory domain to be reduced in the video decoding device without causing an inconsistency of the reference picture pixel value to occur between the video encoding device and the video decoding device. In other words, the memory capacity and the memory domain can be reduced in the video decoding device while the data transfer amount necessary for maintaining the image quality of the decoded video between the video encoding device and the video decoding device is suppressed. The reason is that the video decoding device receives the control information specifying an operation of the memory compression and the memory decompression as the bitstream from the video encoding device, and the demultiplexer 205 supplies it to the memory compression and decompression controller 206, thereby enabling the video decoding device to perform a memory compressing and decompressing process identical to the memory compressing and decompressing process performed by the video encoding device.

Above, an explanation of the video decoding device relating to the second exemplary embodiment of the present invention is finished.

### Third Exemplary Embodiment

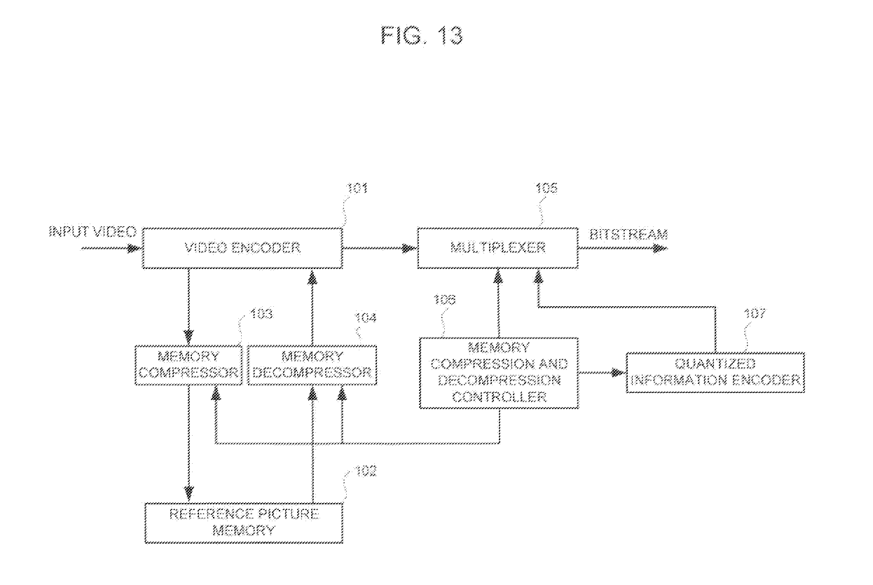

FIG. 13 is a block diagram of the video encoding device relating to the third exemplary embodiment of the present invention. As shown in the figure, the video encoding device relating to the third exemplary embodiment differs in a point of newly including a quantized information encoder 107 as its constituent element, as compared with the video encoding device relating to the first exemplary embodiment shown in FIG. 4. Operations of a video encoder 101, a memory compressor 103 and a memory decompressor 104 are identical to the operations of respective constituent elements in the video encoding device relating to the first exemplary embodiment, so each block of the remaining constituent elements will be explained hereinafter.

The memory compression and decompression controller 106 supplies the control information specifying an operation of the memory compression and the memory decompression to the multiplexer 105. However, the memory compression and decompression controller 106 supplies quantized information to be included in the control information to the multiplexer 105 via the quantized information encoder 107. Additionally, the memory compression and decompression controller 106 may supply the quantized information to the multiplexer 105, in addition to supplying it to the quantized information encoder 107.

The quantized information encoder 107 compression-encodes the quantized information to be supplied from the memory compression and decompression controller 106 based on a predetermined method, and supplies it as a quantized information bitstream to the multiplexer 105.

The multiplexer 105 multiplexes the video bitstream, the above-mentioned control information to be supplied from the memory compression and decompression controller 106, and the quantized information bitstream to be supplied from the quantized information encoder 107, and outputs them as the bitstream.

By making a configuration in such a manner, an effect that the data transfer amount necessary for maintaining the image quality of the decoded video between the video encoding device and the video decoding device can be furthermore reduced is obtained, in addition to the effect to be obtained by the video encoding device relating to the first exemplary embodiment. The reason is that the data amount necessary for transmitting the control information can be reduced because the control information specifying an operation of the memory compression and the memory decompression is compression-encoded by the quantized information encoder 107.

### Example 2

A specific example of the above-mentioned video encoding device relating to the third exemplary embodiment will be explained below.

In this example, similarly to the specific example of the video encoding device relating to the first exemplary embodiment, it is assumed that the memory compressor 103 and the memory decompressor 104 performs the compression and decompression based on the DPCM for encoding the predicted error at M bits with the processing interval assumed to be N pixels, respectively. Further, it is assumed that the element value of the quantized representative value array is a variable value and the element value of the quantized representative value array is supplied as the control information to the quantized information encoder 107.

Herein, an operation of the quantized information encoder 107 will be specifically explained by listing an example.

Similarly to the description in the specific example of the video encoding device relating to the first exemplary embodiment, it is assumed that a predetermined quantized representative value array is epqr(i) (i=0, 1, . . . , 2^{M}−1). Further, it is assumed that epqr(0)=0. At this time, the quantized information encoder 107 obtains array depqr(i) (i=1, . . . , 2^{M}−1) of difference values between the neighboring elements for the quantized representative value array from Equation (9).

[Numerical equation 9]

depqr(i)=epqr(i)−epqr(i−1) Equation (9)

The quantized information encoder 107 subjects this array depqr(i) (i=1, . . . , 2^{M}−1) to variable-length coding based on unsigned Exp-Golomb Code, being one of entropy codes, and outputs it as the quantized information bitstream.

When a distribution of the quantized representative value arrays is close to a linear function, an array of difference values is inclined to concentrate on a predetermined range in terms of the value, as compared with the original quantized representative value array, whereby applying the entropy coding therefor makes it possible to reduce the data amount necessary for transmitting the quantized representative value array all the more.

Further, the quantized information encoder 107 may obtain array ddeqpr(i) (i=1, . . . , 2^{M}−1) of second difference values between the neighboring elements for the quantized representative value array instead of depqr(i) of Equation (9) from Equation (10) to output a value obtained by subjecting this array ddeqpr(i) (i=1, . . . , 2^{M}−1) to the variable-length coding based on signed Exp-Golomb Code as the quantized information bitstream.

[Numerical equation 10]

depqr(i)=depqr(i)−depqr(i−1) Equation (10)

where, it is assumed that depqr(0)=1.

When the quantized representative value array can be expressed by employing a smooth monotone increasing function, an array of second difference values is inclined to concentrate on 0 (zero) in terms of the value, as compared with the original quantized representative value array, whereby applying the entropy coding therefor makes it possible to reduce the data amount necessary for transmitting the quantized representative value array all the more. Or, when dpcm_qmatrix_asymmetry_flag=0 in a case in which a value of dpcm_qmatrix_asymmetry_flag indicating whether or not epqr(i) has asymmetry is satisfied by both of Equation (11) and Equation (12), and when dpcm_qmatrix_asymmetry_flag=1 in a case other than this, the quantized information encoder 107 may output a data array obtained by encoding epqr(i) (i=0, . . . , 2^{M-1}−1) based on a B-bit fixed-length code, and the above-mentioned dpcm_qmatrix_asymmetry_flag as the quantized information bitstream.

[Numerical equation 11]

epqr(i)=2^{B}−epqr(2^{M}−i); i>2^{M-1} Equation (11)

[Numerical equation 12]

epqr(2^{M})=2^{B-1} Equation (12)

The elements of the array that should be transmitted can be reduced at a half with this, whereby the data amount necessary for transmitting the quantized representative value array can be reduced all the more.

Further, the quantized information encoder 107 may output a data array obtained by subjecting depqr(i) (i=1, . . . , 2^{M-}−1) to the variable-length coding based on unsigned Exp-Golomb Code and dpcm_qmatrix_asymmetry_flag as the quantized information bitstream.

Further, the quantized information encoder 107 may output a data array obtained by subjecting ddepqr(i) (i=1, . . . , 2^{M-1}−1) to the variable-length coding based on signed Exp-Golomb Code, and dpcm_qmatrix_asymmetry_flag as the quantized information bitstream.

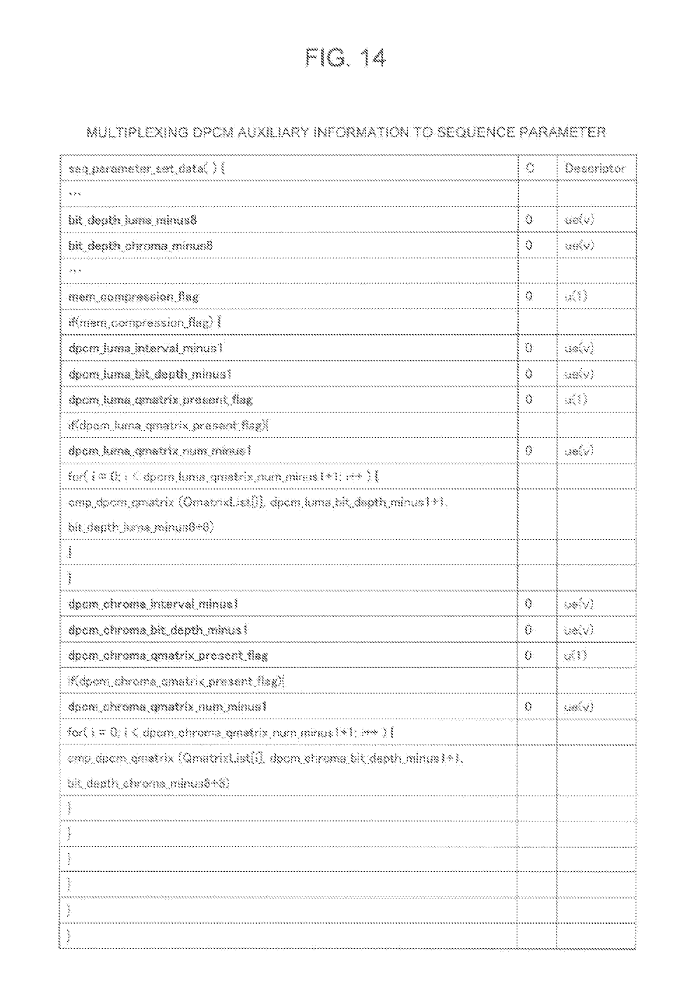

When the quantized information encoder 107 outputs the data array, being a encoding result of depqr(i) (i=1, . . . , 2^{M}−1) as the quantized information bitstream, the DPCM auxiliary information and the quantized information bitstream may be multiplexed to the sequence parameter, for example, in accordance with the description of “Specification of syntax functions, categories, and descriptors” of the Non-Patent Literature 1, as exemplified in lists of FIG. 14 and FIG. 15.

The above-mentioned multiplexing may be performed for each GOP, being a random access interval.

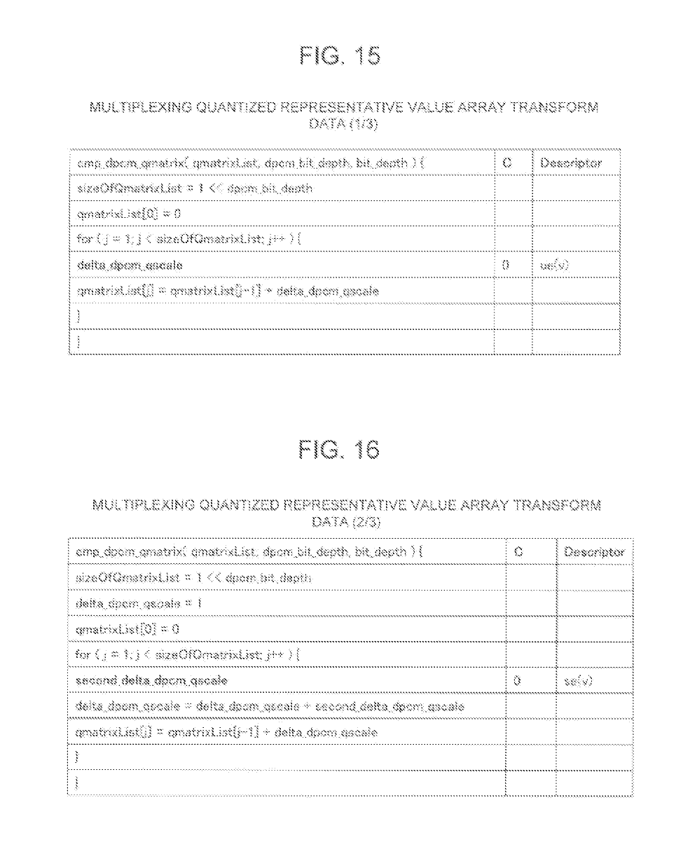

Further, when the quantized information encoder 107 outputs the data array, being a encoding result of ddepqr(i) (i=1, . . . , 2^{M}−1), as the quantized information bitstream, the DPCM auxiliary information and the quantized information bitstream may be multiplexed to the sequence parameter, for example, in accordance with the description of “Specification of syntax functions, categories, and descriptors” of the Non-Patent Literature 1, as exemplified in lists of FIG. 14 and FIG. 16.

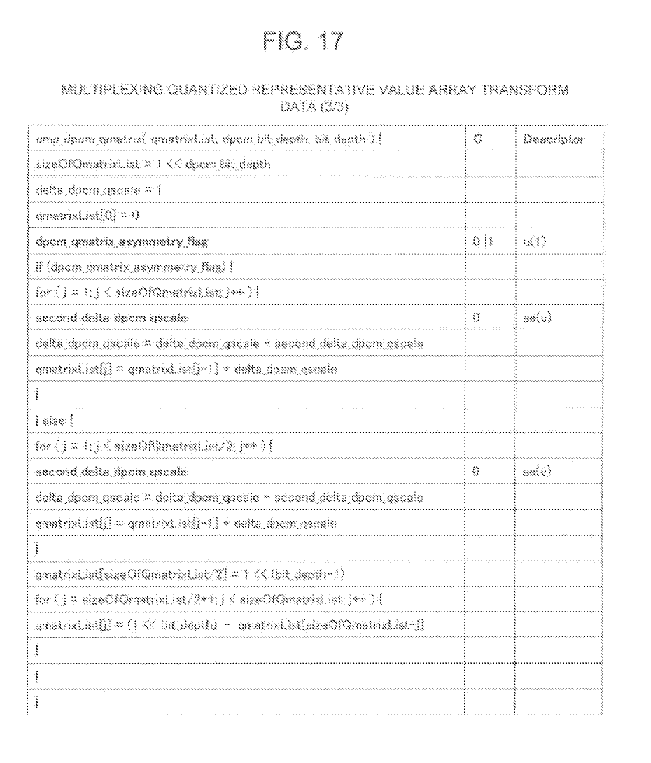

Further, when the quantized information encoder 107 outputs the data array, being a encoding result of ddepqr(i) (i=1, . . . , 2^{M-1}−1) and dpcm_qmatrix_asymmetry_flag as the quantized information transform bitstream, the DPCM auxiliary information and the quantized information bitstream may be multiplexed to the sequence parameter, for example, in accordance with the description of “Specification of syntax functions, categories, and descriptors” of the Non-Patent Literature 1, as exemplified in lists of FIG. 14 and FIG. 17.

Additionally, delta_dpcm_qscale denotes an element value of an array of difference values between the neighboring elements for the quantized representative value array.

Further, second_delta_dpcm_qscale denotes an element value of an array of second difference values between the neighboring elements for the quantized representative value array.

With regard to syntax elements other than them, the content thereof is identical to the content explained in the specific example of the video encoding device relating to the first exemplary embodiment, so its explanation is omitted.

Above, an explanation of the example of multiplexing the DPCM auxiliary information in FIG. 14 to FIG. 17 is finished.

In this example, at the moment of encoding the difference value or the second difference value, an example of encoding it based on Exp-Golomb Code was shown; however, the present invention is not limited hereto and the encoding based on other entropy codes may be performed. For example, the encoding based on Huffman code and arithmetic code may be performed. In addition, the encoding may be performed by employing an arbitrary code other than the entropy codes.

Further, in this example, an example of transforming the quantized representative value array into the difference value or the second difference value and encoding it was shown; however, the present invention is not limited hereto and a value obtained by transforming the quantized representative value array into a set of coefficient values of the linear function or the like may be encoded.

Further, in this example, with regard to the DPCM auxiliary information, an example of multiplexing the DPCM auxiliary information to the bitstream for the luminance signal and the chromaticity signal, respectively, was shown. However, in accordance with the present invention, it may be acceptable to have, for example, only one common set of the DPCM auxiliary information.

Further, it may be acceptable to have, for example, different DPCM auxiliary information for all color planes. In addition, with regard to an entirety or one part of the auxiliary information, a fixed value common to the video encoding device and the video decoding device may be set.

Further, in this example, with regard to the DPCM auxiliary information, an example of multiplexing the information of a plurality of the quantized representative value array to the bitstream was shown. In such examples, in the present invention, it is also possible to switch the quantized representative value array for each processing interval of the DPCM by multiplexing index information of the quantized representative value array selected by the memory compressor of the video encoding device to the DPCM compressed data.

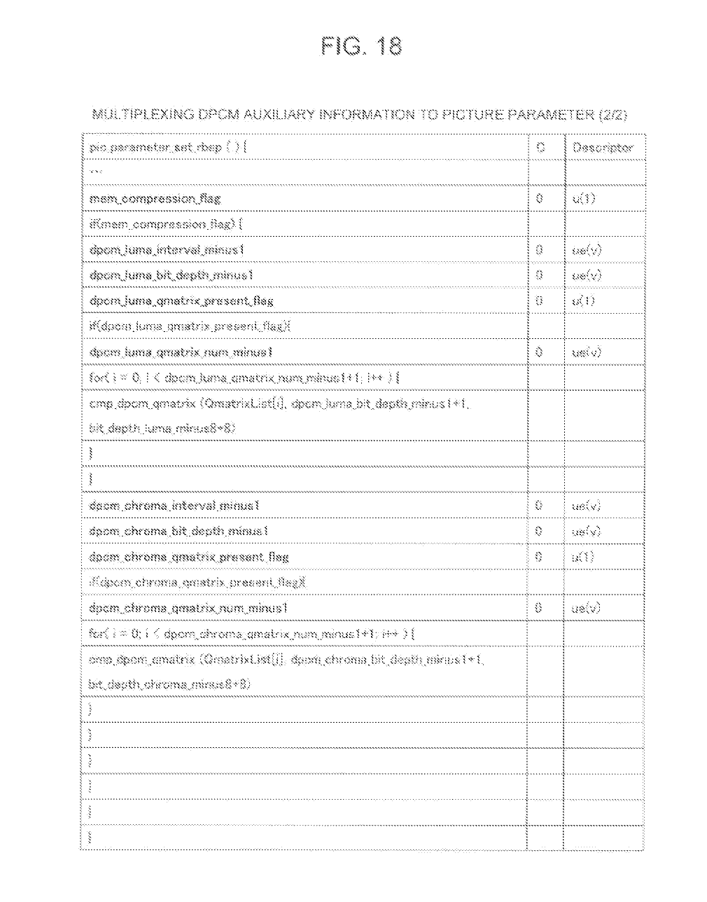

Further, in this example, an example of multiplexing the DPCM auxiliary information to the sequence parameter was shown. However, in accordance with the present invention, for example, the DPCM auxiliary information may be multiplexed in the picture parameter to be employed for by-frame encoding and decoding as exemplified in a combination of a list of FIG. 18 and any one of lists of FIG. 15 to FIG. 17. By multiplexing the DPCM auxiliary information to the picture parameter in such a manner, it is also possible switch the special feature of the DPCM compression in a unit of the frame.

Above, an explanation of the video encoding device relating to the third exemplary embodiment of the present invention is finished.

### Fourth Exemplary Embodiment

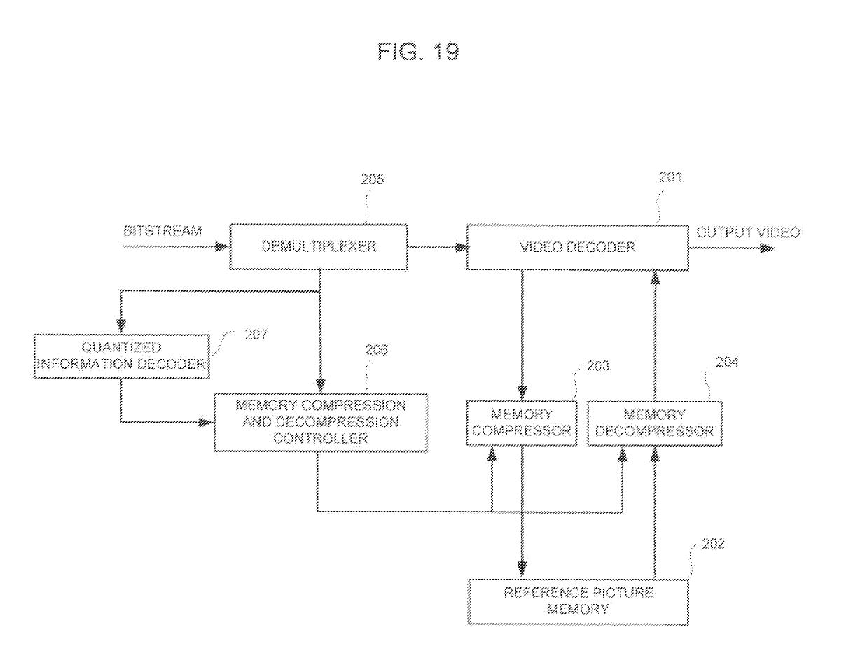

FIG. 19 is a block diagram of the video decoding device relating to the fourth exemplary embodiment of the present invention. As shown in the figure, the video decoding device relating to the fourth exemplary embodiment differs in a point of newly including a quantized information decoder 207 as its constituent element, as compared with the video decoding device relating to the second exemplary embodiment shown in FIG. 10. Operations of a video decoder 201, a memory compressor 203, a memory decompressor 204, and a memory compression and decompression controller 206 are identical to the operations of respective constituent elements in the video decoding device relating to the third exemplary embodiment, respectively, so each block of the remaining blocks will be explained hereinafter.

The demultiplexer 205 demultiplexes the bitstream, and extracts the video bitstream, the control information specifying an operation of the memory compression and the memory decompression, and the quantized information bitstream. Further, the demultiplexer 205 supplies the extracted control information, the extracted quantized information bitstream, and the extracted video bitstream to the memory compression and decompression controller 206, the quantized information decoder 207, and the video decoder 201, respectively.

The quantized information decoder 207 decodes the quantized information bitstream to be supplied from the demultiplexer 205 based on a predetermined method, and supplies it to the memory compression and decompression controller 206 as the quantized information, being one part of the control information specifying an operation of the memory compression and the memory decompression.

By making a configuration in such a manner, an effect that the data transfer amount necessary for maintaining the image quality of the decoded video between the video encoding device and the video decoding device can be furthermore reduced is obtained, in addition to the effect to be obtained by the video decoding device relating to the second exemplary embodiment. The reason is that the data amount necessary for transmitting the control information can be reduced because the control information specifying an operation of the memory compression and the memory decompression can be taken out from the compression-encoded quantized bitstream by the quantized information decoder 207.

### Fifth Exemplary Embodiment

Further, the present invention is also applicable to a field in which when a bit depth of the input video is decompressed and video-encoded as is the case with the Non-Patent Literature 2, the reference picture memory that is increased responding to the decompressed bit depth is reduced.

Besides, the exemplary embodiments of the present invention described above can be also configured with hardware as apparent from the above-described explanation; however, the exemplary embodiments can be also realized with a computer program.

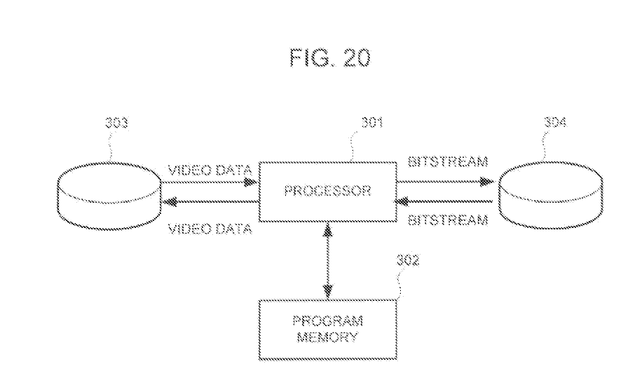

An information processing system shown in FIG. 20 is comprised of a processor 301, a program memory 302, and storage media 303 and 304. The storage media 303 and 304 could be a separate record medium, respectively, and could be a storage region comprised of an identical storage medium. A magnetic storage medium such as hard disc may be employed as the storage medium.

Further, the content of the above-mentioned exemplary embodiments can be expressed as follows.

(Supplementary note 1) A video encoding device, comprising:

a video encoding means that encodes an input video based on a prediction;

a reference picture compressing means that compresses a reference picture to be employed for said prediction;

a reference picture storing means that stores said compressed reference picture;

a reference picture decompressing means that decompresses the compressed reference picture stored into said reference picture storing means;

a compression and decompression controlling means that controls said reference picture compressing means and said reference picture decompressing means based on predetermined control information;

a quantized information encoding means that encodes one part of the control information of said compression and decompression controlling means with a predetermined method and generates a quantized information bitstream; and

a multiplexing means that multiplexes the video bitstream of said video encoding means, at least the control information other than the information encoded by said quantized information encoding means, out of said control information, and said quantized information bitstream.

(Supplementary note 2) The video encoding device according to Supplementary note 1:

wherein the control information of said compression and decompression controlling means includes at least an array of quantized representative values; and

wherein said quantized information encoding means encodes said array of the quantized representative values and generates the quantized information bitstream.

(Supplementary note 3) The video encoding device according to Supplementary note 2, wherein said quantized information encoding means adds a flag indicating whether or not said array of the quantized representative values has symmetry to said quantized information bitstream.

(Supplementary note 4) The video encoding device according to Supplementary note 2 or Supplementary note 3, wherein said quantized information encoding means generates the quantized information bitstream by employing an array of difference values between elements for said array of the quantized representative values.

(Supplementary note 5) The video encoding device according to Supplementary note 2 or Supplementary note 3, wherein said quantized information encoding means generates the quantized information bitstream by employing an array of second difference values between elements for said array of the quantized representative values.

(Supplementary note 6) A video decoding device, comprising:

a demultiplexing means that demultiplexes a bitstream in which a quantized information bitstream having one part of control information of a compression and decompression control encoded therein, the control information other than said one part of the information, and a video bitstream have been multiplexed;

a quantized information decoding means that decodes the demultiplexed quantized information bitstream with a predetermined method, and extracts said control information of the compression and decompression control;

a video decoding means that decodes the demultiplexed video bitstream based on a prediction;

a reference picture compression means that compresses a reference picture to be employed for said prediction;

a reference picture storing means that stores said compressed reference picture;

a reference picture decompressing means that decompresses the compressed reference picture stored into said reference picture storing means; and

a compression and decompression controlling means that controls said reference picture compressing means and said reference picture decompressing means based on said demultiplexed control information and said extracted control information.

(Supplementary note 7) The video decoding device according to Supplementary note 6, wherein said quantized information decoding means extracts an array of quantized representative values from said quantized information bitstream.

(Supplementary note 8) The video decoding device according to Supplementary note 7, wherein said quantized information decoding means extracts a flag indicating whether or not said array of the quantized representative values has symmetry from said quantized information bitstream.

(Supplementary note 9) The video decoding device according to Supplementary note 7 or Supplementary note 8, wherein said quantized information decoding means obtains said array of the quantized representative values by decoding an array of difference values between elements from said quantized bitstream.

(Supplementary note 10) The video decoding device according to Supplementary note 7 or Supplementary note 8, wherein said quantized information decoding means obtains said array of the quantized representative values by decoding an array of second difference values between elements from said quantized bitstream.

(Supplementary note 11) A video encoding method, comprising:

encoding an input video based on a prediction;

compressing a reference picture to be employed for said prediction based on a predetermined control information;

storing said compressed reference picture;

decompressing said stored compressed reference picture based on said predetermined control information;

encoding one part of said control information with a predetermined method and generating a quantized information bitstream; and

multiplexing said encoded video bitstream, said quantized information bitstream, at least the control information other than said encoded information.

(Supplementary note 12) The video encoding method according to Supplementary note 11:

wherein said control information includes at least an array of quantized representative values; and

wherein said encoding and said generating encodes said array of the quantized representative values and generates the quantized information bitstream.

(Supplementary note 13) The video encoding method according to Supplementary note 12, wherein said generating adds a flag indicating whether or not said array of the quantized representative values has symmetry to said quantized information bitstream.

(Supplementary note 14) The video encoding method according to Supplementary note 12 or Supplementary note 13, wherein said generating generates the quantized information bitstream by employing an array of difference values between elements for said array of the quantized representative values.

(Supplementary note 15) The video encoding method according to Supplementary note 12 or Supplementary note 13, wherein said generating generates the quantized information bitstream by employing an array of second difference values between elements for said array of the quantized representative values.

(Supplementary note 16) A video decoding methods, comprising:

demultiplexing a bitstream in which a quantized information bitstream having one part of control information of a compression and decompression control encoded therein, at least the control information of the compression and decompression control other than said one part of the information, and a video bitstream have been multiplexed;

decoding the demultiplexed quantized information bitstream with a predetermined method, and extracting said control information of the compression and decompression control;

decoding the demultiplexed video bitstream based on a prediction;

compressing a reference picture to be employed for said prediction based on said demultiplexed control information and said extracted control information;

storing said compressed reference picture; and

decompressing said stored compressed reference picture based on said demultiplexed control information and said extracted control information.

(Supplementary note 17) The video decoding method according to Supplementary note 16, wherein said decoding of the quantized information extracts an array of quantized representative values from said quantized information bitstream.

(Supplementary note 18) The video decoding method according to Supplementary note 17, wherein said decoding of the quantized information extracts a flag indicating whether or not said array of the quantized representative values has symmetry from said quantized information bitstream.

(Supplementary note 19) The video decoding method according to Supplementary note 17 or Supplementary note 18, wherein said decoding of the quantized information obtains said array of the quantized representative values by decoding an array of difference values between elements from said quantized bitstream.

(Supplementary note 20) The video decoding method according to Supplementary note 17 or Supplementary note 18, wherein said decoding of the quantized information obtains said array of the quantized representative values by decoding an array of second difference values between elements from said quantized bitstream.

(Supplementary note 21) A program for causing an information processing device to execute the processes of:

encoding an input video based on a prediction;

compressing a reference picture to be employed for said prediction based on a predetermined control information;

storing said compressed reference picture;

decompressing said stored compressed reference picture based on said control information;

encoding one part of said control information with a predetermined method and generating a quantized information bitstream; and

multiplexing said encoded video bitstream, said quantized information bitstream, and the control information other than said encoded information.

(Supplementary note 22) A program for causing an information processing device to execute the processes of:

demultiplexing a bitstream in which a quantized information bitstream having one part of control information of a compression and decompression control encoded therein, the control information other than said one part of the information, and a video bitstream have been multiplexed;

decoding the demultiplexed quantized information bitstream with a predetermined method, and extracting said control information;

decoding the demultiplexed video bitstream based on a prediction;

compressing a reference picture to be employed for said prediction based on said demultiplexed control information and said extracted control information;

storing said compressed reference picture; and

decompressing said stored compressed reference picture based on said demultiplexed control information and said extracted control information.

Above, although the present invention has been particularly described with reference to the preferred embodiments and examples, it should be readily apparent to those of ordinary skill in the art that the present invention is not always limited to the above-mentioned embodiments and examples, and changes and modifications in the form and details may be made without departing from the spirit and scope of the invention.

This application is based upon and claims the benefit of priority from Japanese patent application No. 2010-174156, filed on Aug. 3, 2010, the disclosure of which is incorporated herein in its entirety by reference.

### REFERENCE SIGNS LIST

101 video encoder
102 reference picture memory
103 memory compressor
104 memory decompressor
105 multiplexer
106 memory compression and decompression controller
107 quantized information encoder
201 video decoder
202 reference picture memory
203 memory compressor
204 memory decompressor
205 demultiplexer
206 memory compression and decompression controller
207 quantized information decoder

1. A video encoding device, comprising:
a video encoder that encodes an input video based on a prediction;
a reference picture compressing unit that compresses a reference picture to be employed for said prediction;
a reference picture storage that stores said compressed reference picture;
a reference picture decompressing unit that decompresses the compressed reference picture stored into said reference picture storage;
a compression and decompression controller that controls said reference picture compressing unit and said reference picture decompressing unit based on predetermined control information;
a quantized information encoder that encodes one part of the control information of said compression and decompression controller with a predetermined method and generates a quantized information bitstream; and
a multiplexer that multiplexes the video bitstream of said video encoder, at least the control information other than the information encoded by said quantized information encoder, out of said control information, and said quantized information bitstream.

2. The video encoding device according to claim 1:
wherein the control information of said compression and decompression controller includes at least an array of quantized representative values; and
wherein said quantized information encoder encodes said array of the quantized representative values and generates the quantized information bitstream.

3. The video encoding device according to claim 2, wherein said quantized information encoder generates the quantized information bitstream by employing an array of second difference values between elements for said array of the quantized representative values.

4. A video decoding device, comprising:
a demultiplexer that demultiplexes a bitstream in which a quantized information bitstream having one part of control information of a compression and decompression control encoded therein, the control information other than said one part of the information, and a video bitstream have been multiplexed;
a quantized information decoder that decodes the demultiplexed quantized information bitstream with a predetermined method, and extracts said control information of the compression and decompression control;
a video decoder that decodes the demultiplexed video bitstream based on a prediction;
a reference picture compression unit that compresses a reference picture to be employed for said prediction;
a reference picture storage that stores said compressed reference picture;
a reference picture decompressing unit that decompresses the compressed reference picture stored into said reference picture storage; and
a compression and decompression controller that controls said reference picture compressing unit and said reference picture decompressing unit based on said demultiplexed control information and said extracted control information.

5. The video decoding device according to claim 4, wherein said quantized information decoder extracts an array of quantized representative values from said quantized information bitstream.

6. The video decoding device according to claim 5, wherein said quantized information decoder obtains said array of the quantized representative values by decoding an array of second difference values between elements from said quantized bitstream.

7. A video encoding method, comprising:
encoding an input video based on a prediction;
compressing a reference picture to be employed for said prediction based on a predetermined control information;
storing said compressed reference picture;
decompressing said stored compressed reference picture based on said predetermined control information;
encoding one part of said control information with a predetermined method and generating a quantized information bitstream; and
multiplexing said encoded video bitstream, said quantized information bitstream, at least the control information other than said encoded information.

8. A video decoding methods, comprising:
demultiplexing a bitstream in which a quantized information bitstream having one part of control information of a compression and decompression control encoded therein, at least the control information of the compression and decompression control other than said one part of the information, and a video bitstream have been multiplexed;
decoding the demultiplexed quantized information bitstream with a predetermined method, and extracting said control information of the compression and decompression control;
decoding the demultiplexed video bitstream based on a prediction;
compressing a reference picture to be employed for said prediction based on said demultiplexed control information and said extracted control information;
storing said compressed reference picture; and
decompressing said stored compressed reference picture based on said demultiplexed control information and said extracted control information.

9. A non-transitory computer readable storage medium storing a program for causing an information processing device to execute the processes of:
encoding an input video based on a prediction;
compressing a reference picture to be employed for said prediction based on a predetermined control information;
storing said compressed reference picture;
decompressing said stored compressed reference picture based on said control information;
encoding one part of said control information with a predetermined method and generating a quantized information bitstream; and
multiplexing said encoded video bitstream, said quantized information bitstream, and the control information other than said encoded information.

10. A non-transitory computer readable storage medium storing a program for causing an information processing device to execute the processes of:
demultiplexing a bitstream in which a quantized information bitstream having one part of control information of a compression and decompression control encoded therein, the control information other than said one part of the information, and a video bitstream have been multiplexed;
decoding the demultiplexed quantized information bitstream with a predetermined method, and extracting said control information;
decoding the demultiplexed video bitstream based on a prediction;
compressing a reference picture to be employed for said prediction based on said demultiplexed control information and said extracted control information;
storing said compressed reference picture; and
decompressing said stored compressed reference picture based on said demultiplexed control information and said extracted control information.

11. The video encoding device according to claim 2, wherein said quantized information encoder adds a flag indicating whether or not said array of the quantized representative values has symmetry to said quantized information bitstream.

12. The video encoding device according to claim 2, wherein said quantized information encoder generates the quantized information bitstream by employing an array of difference values between elements for said array of the quantized representative values.

13. The video decoding device according to claim 5, wherein said quantized information decoder extracts a flag indicating whether or not said array of the quantized representative values has symmetry from said quantized information bitstream.

14. The video decoding device according to claim 5, wherein said quantized information decoder obtains said array of the quantized representative values by decoding an array of difference values between elements from said quantized bitstream.

15. The video encoding method according to claim 7:
wherein said control information includes at least an array of quantized representative values; and
wherein said encoding and said generating encodes said array of the quantized representative values and generates the quantized information bitstream.

16. The video encoding method according to claim 15, wherein said generating generates the quantized information bitstream by employing an array of second difference values between elements for said array of the quantized representative values.

17. The video decoding method according to claim 8, wherein said decoding of the quantized information extracts an array of quantized representative values from said quantized information bitstream.

18. The video decoding method according to claim 17, wherein said decoding of the quantized information obtains said array of the quantized representative values by decoding an array of second difference values between elements from said quantized bitstream.
